(19) United States
(12) Patent Application Publication
(10) Pub. No.: US 2011/0191684 A1
(43) Pub. Date: Aug. 4, 2011

(54) Method of Internet Video Access and Management

(75) Inventor: Jonathan Greenberg, Sebastopol, CA (US)

(73) Assignee: TV1.COM HOLDINGS, LLC, Sebastopol, CA (US)

(21) Appl. No.: 13/081,360

(22) Filed: Apr. 6, 2011

Related U.S. Application Data
(63) Continuation-in-part of application No. 12/493,248, filed on Jun. 29, 2009.
(60) Provisional application No. 61/076,688, filed on Jun. 29, 2008.
(60) Provisional application No. 61/321,643, filed on Apr. 7, 2010.

(51) Int. Cl. G06F 3/01

(52) U.S. Cl. 715/719

(57) ABSTRACT

A system and apparatus for enabling the end user to schedule the display of online videos and dynamically displaying online videos according to a user preference. The system provides an editorially-selected guide to online videos in which videos from existing online video providers are gathered under a single portal and thereby provides the end user a directory through which the user can view recommended videos as presented by the system, or personalize the selections into a dynamically-generated subset of videos. The system also provides a seamless playlist of multiple videos from various websites, and allows the user to manage and re-sequence this playlist.

### CROSS REFERENCE TO RELATED APPLICATIONS

The present application is a continuation-in-part of and claims priority to the U.S. non-provisional patent application of the same title having application Ser. No. 12/493,248, that filed on Jun. 28, 2009, and which is incorporated herein by reference.

The present application also claims priority to the U.S. provisional application having Ser. No. 61/321,643, of the same title, that was filed on Apr. 7, 2010, which is incorporated herein by reference

The present application also claims priority to the U.S. provisional application having Ser. No. 61/076,688 of the same title, that was filed on Jun. 29, 2008, which is incorporated herein by reference

### BACKGROUND OF INVENTION

The present invention relates to the selection and display of video available on the Internet

The Internet has in the last several years become a popular means for distributing and viewing video content from a wide variety of media sources, as well as user generated video content.

However, this popularity also creates the dilemma for the end users that do not have enough free time to browse all the available Internet video resources for content of interest, such as news, entertainment, educational media and the like.

Accordingly, it is an object of the invention to provide such end users with an improved means to access quality video media of interest on the Internet.

It is another object of the invention to provide an improved means for collection, storing and organizing video media for access by others.

It is another object of the invention to provide an improved means for commenting on such video media, and collecting, storing and organizing the commentary of the user and the commentary of others.

### SUMMARY OF INVENTION

Generally speaking, the invention relates to innovative techniques to generate a directory of videos from existing online digital videos whereby the end user is enabled to aggregate videos that are selected by editors from multiple web video websites

The end user can specify preferences and the system dynamically generates a listing subset of editor-selected videos that satisfy these preferences. From that listing the videos can be selected and scheduled for play by the end user. A second aspect of the invention is that videos are selected and scheduled for play according to the user's individual preference to enable the end user to sequentially watch the end product of the scheduling—the individualized program—in an automatic “playlist” fashion which forgoes the problem of having to travel to various websites or search for a new video to see more than one web video. A third aspect of the invention is that videos are selected to add to a user's library or database of stored references, which can reside on a remote server that hosts the editor selected videos, on the user's computer or another computer or server.

Another inventive aspect is the system displays the total length of the program, comprised of various web videos from the website that are selected and sequenced by the end user.

Another aspect of the invention is achieved by providing a method of Internet video content management comprising obtaining a plurality of URL's that provides video content, viewing the video content of the URL's, selecting a portion of the URL's to recommend for access by others in the form of a playlist, characterizing the video content of the playlist by attributes of, which include: a name associated with the party that made the selection in the previous step, a category, and the total play time, and then storing the URLs of the video content and the attributes in a data structure that is computer readable.

A further aspect of the invention is a method of viewing video content on a connected network of servers comprising the steps of defining user preferences to form a customer menu that comprises categories of content, providing an end-user with a GUI in which a matrix of potential videos is presented organized by the categories of content, selecting potential videos in the GUI to form a playlist for the sequential play of the selected videos, initiating the play of the playlist by the end-user via a web browser on a media device in signal communication with the network, wherein said step of initiating play causes the further steps of acquiring a series of URL's to form a view script in accordance with the playlist, the view script comprising the series of URL's and playtimes for each URL, wherein the view script is operative for directing the end-user web browser to the first URL in the selected series in the play list for a first predetermined amount of time, and then directing the end-user web browser to at least one subsequent URL in the view list after the previous predetermined playtime for the subsequent predetermined playtime.

Yet still another aspect of the invention is a graphic user interface (GUI) for viewing a collection of videos that comprises a matrix of potential videos organized by categories of content, wherein 2 or more choices are presented in each category portion of the matrix, each element in the matrix including at least one of: a sample video frame, a title and a play time, wherein the GUI is operative to develop and display a playlist for the content by the selection of matrix elements using icons with the element.

Still another aspect of the invention is a graphic user interface (GUI) for viewing an interactive video editorial created by a human agent, the GUI comprising a plurality of icons, each icon representing a different video available for play in the substantially complete sequence from a hosting server by designating a URL, a first viewing frame for viewing any of the videos represented by said plurality of icons, a control icon operative to view a video comprising portion of each of the videos in the plurality interspersed with commentary thereof between each of the portions in the first viewing frame, wherein selecting one of the plurality of icons cause the video so selected to be viewed in the first viewing frame.

A still further aspect of the invention a method of Internet video content management, comprising the steps of accessing one or more web sites hosting playable video content, playing at least a portion of the video content in a GUI having a bookmarklet that is operative to activate a script for acquiring the URL of the playable content and the metadata associated therewith, activating the bookmarklet to open a new GUI that displays the metadata associated with the video content that was played, editing the metadata associated with the video content that was played, storing the edited metadata and the URL of the playable content in a data structure that is computer readable.

Another aspect of the invention is the above method of Internet video content management further comprising the steps of activating the bookmarklet to open a plurality of new GUI that displays the metadata associated with the video content that was played, editing the metadata associated with the video content of at least one of the video that was played, storing the edited metadata and the URL of the playable content in a data structure that is computer readable, accessing the data structure of the previous step to play the video URL's in sequence in a GUI having a first frame for playing each video segment and a second frame adjacent thereto for displaying the edited metadata of each video segment as it is played.

The above and other objects, effects, features, and advantages of the present invention will become more apparent from the following description of the embodiments thereof taken in conjunction with the accompanying drawings.

### BRIEF DESCRIPTION OF THE DRAWINGS

FIG. 1 is a schematic view of a first Graphic User Interface (GUI) for creating a video playlist.

FIG. 2A is a flow chart showing the process for video characterization used to select videos for potential inclusion in the GUI of FIG. 1.

FIG. 2B is a flow chart for the process of using the GUI of FIG. 1 to create a selective playlist of videos that are characterized according to the process of FIG. 2A.

FIG. 3 is a flow chart for the process of the playlist execution.

FIG. 4 is a flow chart for an alternative embodiment of the process of playlist execution.

FIG. 5 illustrates one embodiment for the derivation of the fingerprint marker data from a video that is optionally used in the process of FIG. 4.

FIG. 6 is a second GUI for editing the video playlist of FIG. 1.

FIG. 7 is another GUI for viewing a interactive video editorial

FIG. 8 is a different time segment of the view of the GUI in FIG. 7.

FIG. 9 is an alternative view selective from the GUI of FIG. 7 or 8 as an editable playlist

FIG. 10 is a GUI for adding video content to the editable playlist of FIG. 9

FIG. 11 is a GUI for saving the editable playlist of FIG. 9 or FIG. 10

FIG. 12 in a GUI for sharing the editable playlist of FIG. 9 or FIG. 10 with another party.

FIG. 13 is a GUI for commenting on the interactive video editorial accessed with the GUI's in FIG. 7-12.

FIG. 14 is a GUI for creating video blogs from user's video library

FIG. 15 is GUI for selecting video blogs for viewing that optionally permits the viewing of blogs created by any user.

FIG. 16 is GUI for editing metadata and/or adding other associated other data with a URL for addition to the user's video library.

FIG. 17 is a GUI for viewing a library of video blogs created by the user and editing each blog therein.

FIG. 18 is a GUI for playing a video blog.

FIG. 19 is a GUI for editing the video sequences in a video blog that has already been created.

FIG. 20 is a GUI for editing the bibliographic summary of a video that is in the video library.

FIG. 21 is a GUI for editing the bibliographic and summary information concerning the selected video blog

FIG. 22 is a GUI for reviewing and editing comments created by third party viewers of a video blog.

### DETAILED DESCRIPTION

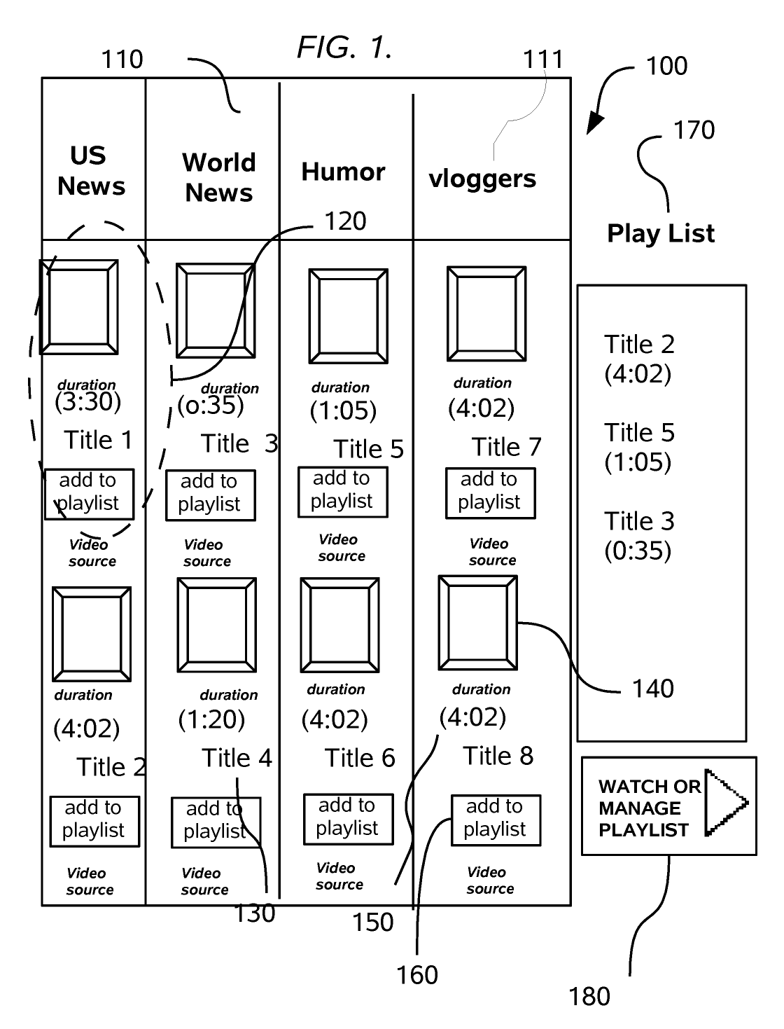

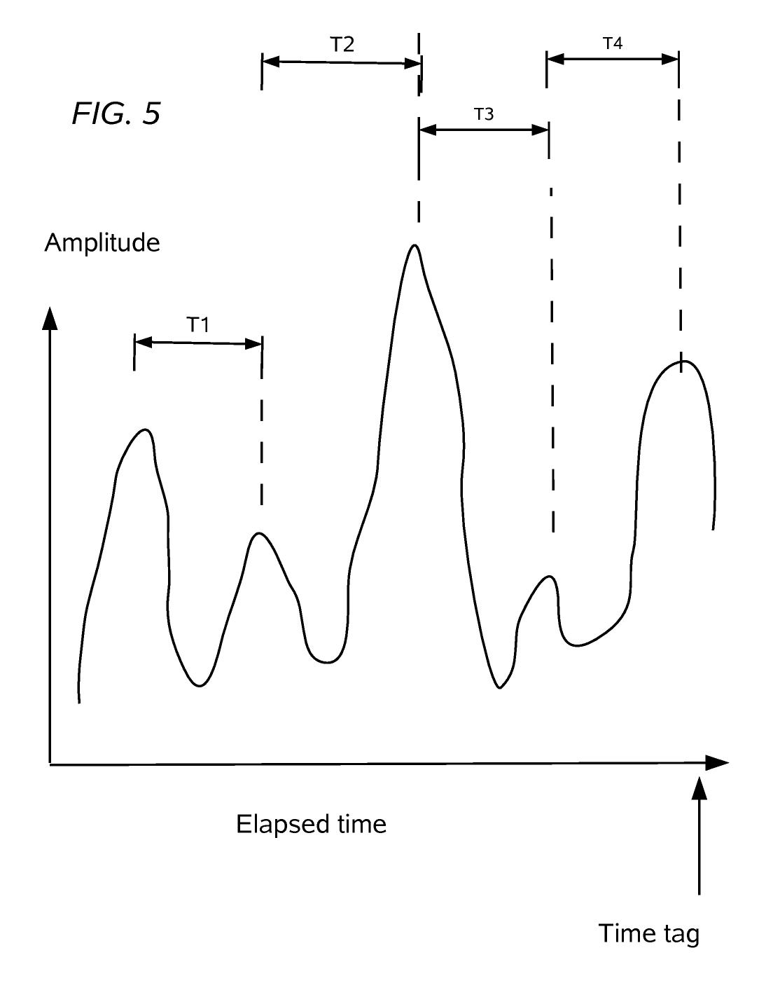

Referring to FIGS. 1 through 22 wherein like reference numerals refer to like components in the various views, there is illustrated therein a new and improved Method of Internet Video Access and Management.

The inventors have come to appreciate that it would be of great benefit to end-users, which is consumers of web video media, to provide a means to view quality content of interest when and where they wanted, including through wired or wireless connection to the Internet, for display over computer screens, TV screens, mobile phones and the like.

Accordingly, it is a first object of the invention to provide a means for users to have an editorially-selected guide for high quality web video content viewable at times controlled by the user.

While it would be possible, at least in theory, to acquire the right to re-play or broadcast Internet video from multiple websites on a single site, this is not practical for several means. One is the dynamic nature of the Internet, and the proliferation of sites featuring news and entertainment. The other is the sheer size of the available material that is dispersed around the world on various servers. Thus, the time and effort involved to negotiate and acquire rights to such content, and then transfer it to a single server or source for play would be inconvenient and unlikely to readily provide as much content as viewers could obtain by going directly to the servers originally hosting the video materials.

Thus, the inventors have come to further appreciate that it is preferable to provide an improved means for end users to find, select and play a variety of editorially-selected, high quality web video that suits their tastes and interests using the native websites that feature such video, therefore avoiding the needs to acquire rights for replay as well as the need to aggregate the media to a single server or service center.

The inventors have also come to appreciate that such an improved means preferably provides end-users with options so that they can make intelligent choices of what to view rapidly, without the need to “cruise” to multiple sites.

The inventors have also come to appreciate that such an improved means preferably provides end-users with the ability to play their selection from the multiple intelligent choices with minimum manual action after such choice is made.

Thus, in accordance with the above discoveries of the problems and needs of users of Internet media there is disclosed herein various embodiments of inventive methods, data structures, and graphic user interfaces that resolves the problem of piecing together multiple web videos from various sites by allowing the user to create and then play a personalized program of these videos to provide a new and improved system for organizing, viewing, storing and sharing web videos.

The inventive method incorporates the dynamic displaying of videos of a specific preference. The system deploying this method operates such that when a specific script indicating a specific content is activated, a metadata of online videos selected through a human editorial processing sifts only videos pertaining to the given content and presents them to the user. The presentation involves a hyperlink-based object locator that is linked to the relevant video from the existing hosting platform, and the metadata comprises of multiple relevant existing hosting platforms.

The system incorporates an online sequential playing of videos from different existing online videos hosts. It enables the user to mix videos from different video hosting platforms. The mixing refers to the capability to combine different videos and put them on a single stream script that displays one video after another in sequence. A deployment of the method involves an interface through which the end user has access to a means for organizing the sequence in which videos are displayed. The process preferably operates entirely online. Other aspects of the invention includes the ability to create other video playlists as well, using diverse sources such as video files on their computer, another computer or servers by storing the URL associated with the stored videos as videos links. The user can optionally upload additional videos to a computer server, and create playlists and along with video commentary on other videos (such as “Vlogs” defined further below), thus creating the user's personal library of stored references, as a database for future retrieval by that user, or for providing access or a custom playlist of selected videos for transmittal to others. The library can contain or provide access to individual videos, URL's for videos and playlists of videos. Various aspects of the present invention improve on existing technology by providing a single portal in which the meta-database associated with existing videos hosted on a plethora of independently run and sponsored websites are combined and generated for the end user to select, choose, and program the online videos according to the individual preference, functioning entirely online. Other aspects of the present invention also involves a human editorial processing of videos by which the online videos to be included in the system are selected.

In a preferred embodiment, end users deploy a standard web browser program on a general purpose computer connected to the Internet or a similar WAN or LAN, to create a playlist. The playlist 170 is simply a sequential order of selected video in which they are to be played. While other websites offer such playlists, they do so using the content available directly from the same website. In the instant invention, the playlist 170 is created from a menu displayed in a graphic user interface (GUI) 100, such as that shown in FIG. 1. This GUI 100 presents video from multiple websites, to enable the sequential play thereof, without the end user needing to personally redirect the browser between the sites hosting each of the videos selected. Preferably, this GUI 100 is presented as a matrix in which the videos of potential of interest are presented as a series of columns 110. The columns 110 are arranged by categories of subject matter, as listed at the top of each column. Alternatively, the presentation can be rotated 90 degrees, with the categories arranged in rows. Each column then has multiple entries 120 beneath the column heading which is in the first row of the matrix. Each entry 120, containing a small “thumbnail” image of that entry 140, represents a video that can be played. The information in the entry 120, as well as the column category it is assigned to, helps the user decide which video to add to the play list 170. Such entries 120 preferably, but without excluding of other information, may include a title 130 and the play time 150. Additional descriptive information may appear when a cursor is placed over a video. The entry 120 may optionally includes rating information, such as the quality rating assigned by a human reviewer, the number of times watched or played by others, a family suitability rating, the source of the video, the author or contributor, and the like. Each entry 120 further includes a control interface 160 that when activated, such as by clicking, adds the video associated with the entry 120 to the play list 170. The playlist 170 is thus dynamically selected by the end-user and displayed at the side, but is also optionally display at top or bottom of the matrix.

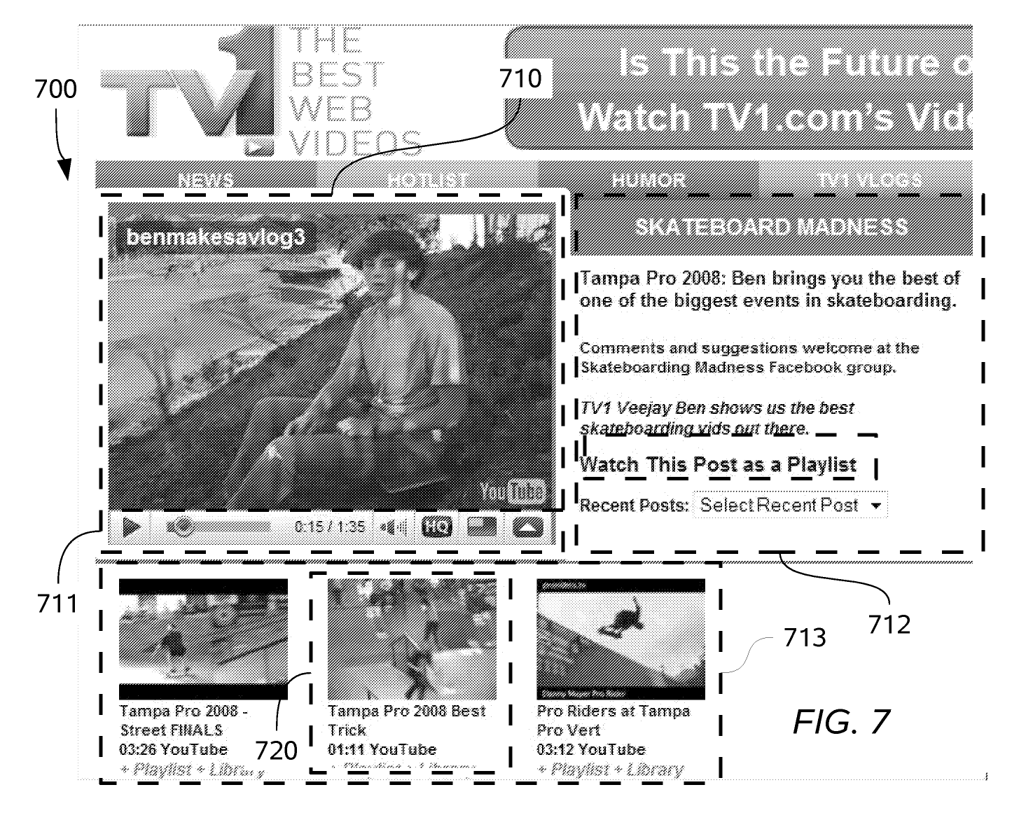

Execution of the playlist can be activated on the GUI 100, through one or more play buttons controls, but preferably as shown a control 180 opens another GUI 600, shown in FIG. 6 that enable the users to both manage the playlist as well as execute it to cause the sequential of each video in the playlist. When the play button is activated, either from GUI 100 or GUI 600, the further execution of the sequential play is automatic. The play button activation then generates a script that directs the end-users web browsers to the URL for the sequence of video in the playlist. The transition from one video to another can be seamless and does not require the end user's inputs. Alternatively, the playlist can execute one video at time in which the user activates an icon to play the next video in the playlist sequence.

The matrix of the GUI 100 in FIG. 1 arises from selection by human editors from thousands of potential websites, with regular updating.

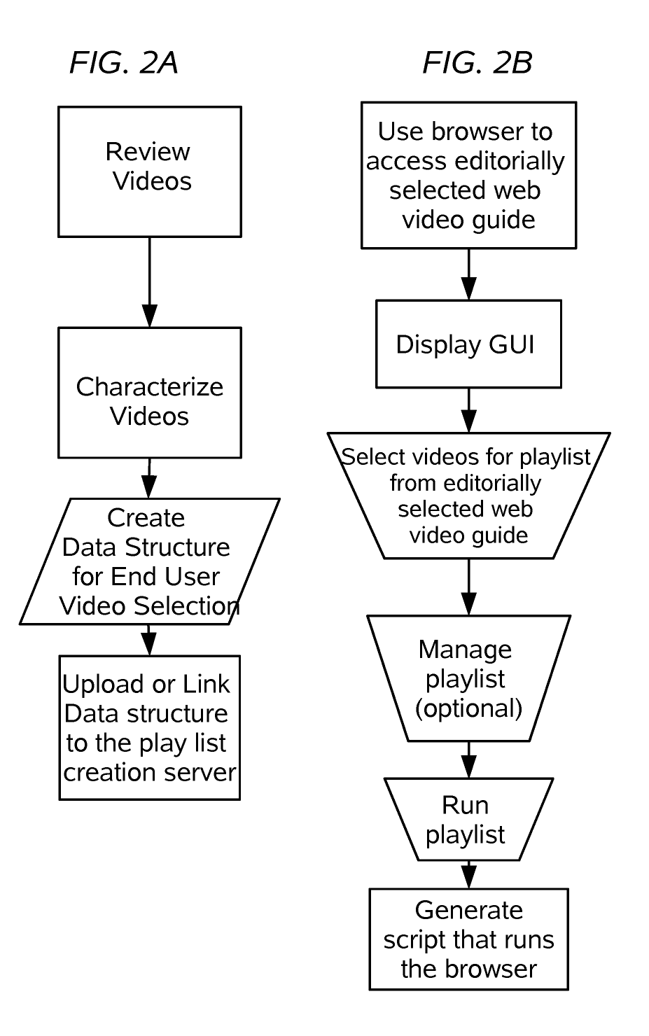

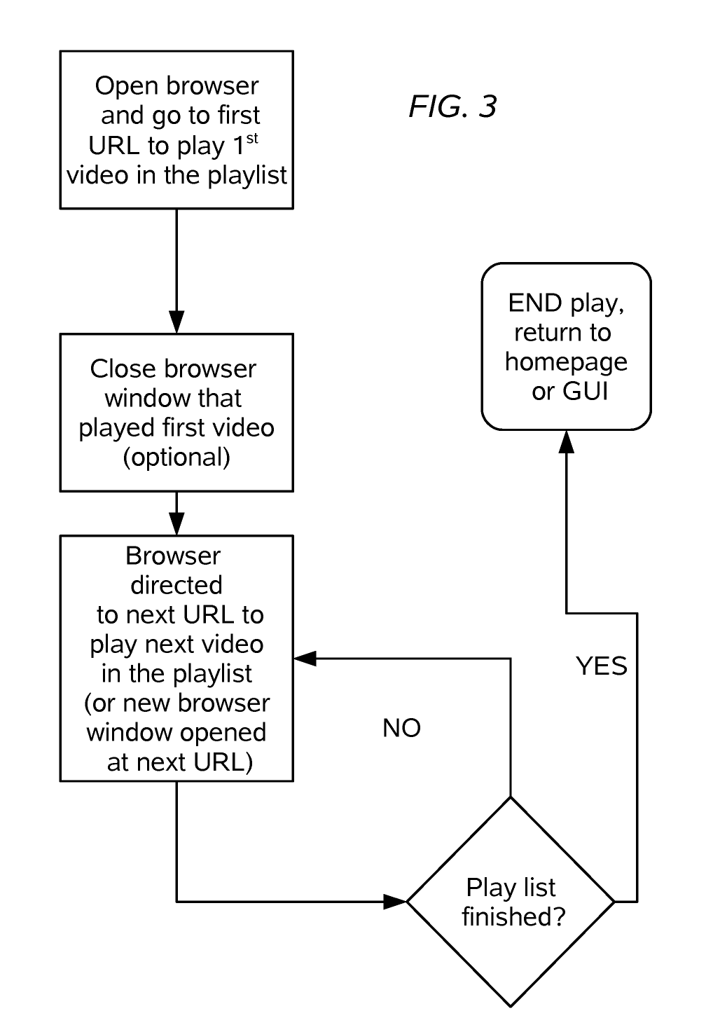

It should be appreciated that some process of selection needs to occur to create the GUI 100 The flow chart in FIG. 2A illustrates the process of charactering video media to enable the generation of the GUI 100 in FIG. 1. In the first step of the process, web videos freely available on the Internet are viewed. The human editor then characterizes the video by either automatically or manually recording at least the information to be placed in each entry 120 in the GUI 100. These recorded characteristics are entered into a data structure that is computer readable such that the GUI 100 draws the information presented in the matrix from the data structure.

Such video attributes subject to characterization and storage in this data structure are akin to and may include any known or future developed form meta-data provided by the native hosting sites, as well as any information the human editors deem useful to end-users in making the playlist selections.

The GUI 100, whether standard or customized, thus enables another aspect of the inventive method by effectively aggregating content through which the web browser serves as a stream script to show a combination of videos.

The characterization generally includes at the least the time and subject title, but may include other characteristics, such as short descriptions, categories, the reviewer's name, or the reviewers rating of the content. The first server that displays the GUI 100 also contains or is linked to the data structure that contains the URL that will direct the browser to other servers that hosts the video. Such a data structure would also contain in association with each video URL at least a title, anticipated play time and at least one still image frame 140 from the video, as well as any other characterization the editor/viewer deems helpful to enable the end users selection from the GUI 100.

The characterization in the data structure is used to place the video frame 140 and associated data in the correct subject column in the GUI of FIG. 1. The characterization can also include a sub-characterization into sequential segments that feature different subjects. For example, an ordinary news broadcasts usually discusses world and national news, local news, sport and assorted human interest stories. It would be valuable to characterize such a video by the time length of each such segment, as this would allow the placement of different segments in different content categories or columns. The GUI 100 provides the end user with sufficient current information to build a custom play list, in effect creating their unique news/entertainment program for the desired length of time.

Accordingly, GUI 100 will include sufficient information that enables a thoughtful choice by each end-user within the categories of interest. Further, it would also be advantageous to also characterize such videos by noting contextual and sequence control markers to aid in the sequential replay of segments found at different web sites.

The present method uses a script software program that combines multiple videos from various serving locations into a seamless program, and allows them to be played back to back without interruption.

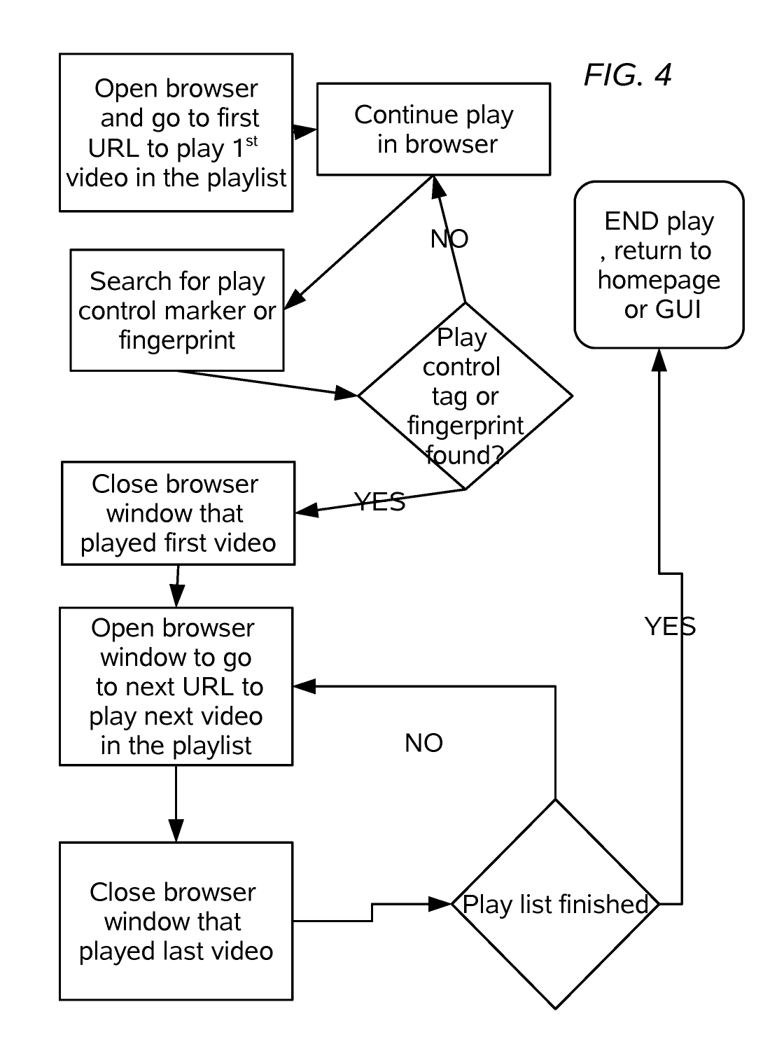

As shown in the flow chart of FIG. 3, when the playlist is run the server hosting the GUI 100 generates a program in the form of a script, such as JavaScript, that is operative to control the user's browser program to access the URL's that direct the browser to the web sites hosting the videos in the playlist. The script contains not only the URL, but the play time of the video as a characteristic. The browser is preferably directed by the script to close the window and go to a subsequent URL in the playlist after the prior play time is reached.

It has been discovered that although a video may have a visible play length that is relatively constant to end-users at different locations or times of day, the actual time that the browser will need to be open at the URL hosting the video, i.e. the displaying server, can vary considerably, depending on the user's connection speed or bit rate, a website's web video serving speed, and the unpredictable inclusion of other material (such as advertising) that could be added from time to time to the beginning or the end of the video segment. To the extent that the time of each video varies from the initial characterization multiple browser windows may be open simultaneously.

If the first or any preceding video takes longer than the playtime 150 characteristic shown in entry 120 of the GUI 100 and stored in the data structure, as for example because it requires more time to fill the video data buffer before the video can play, then this video window would close before the entire video content is played for the end-user. This could result in the simultaneous opening of the next browser window to show the subsequent video in the playlist. Thus, a viewer might miss the beginning of the next video while they are viewing the end of the previous video. Alternatively, if it plays faster, the end-user may need to wait until the script causes the next video in the playlist sequence to open. If these overlaps or delays are too frequent or too long, the end-user may become frustrated and not enjoy what is intended to be a seamless viewing experience.

Hence, it is more preferable in another embodiment of the invention that the script generated by activation of the play button in GUI 100, or another program, such as a native program running on the computer or via a plug in program to the browser, be operative to monitor the progress of each video before it opens the next window. If the selected video has ended faster than predicted, the script, or alternative program, preferably directs the browser to the URL of the next playlist entry. If the video has not ended in the time length predicted the script delays directing the browser to the next URL.

One mode of such a control embodiment described above can be based on providers of video content, the native sites, to provide embedded markers that can be “read” by the browser or other program, but would not be visible or audible to the end-users, unless so desired. The marker characterization would be part of the characterization process in FIG. 2A, and be added to the data structure that generates the entries into the GUI 100 and the control script associated with the play function. The script would be operative to sequence the opening and closing of new browser windows, as well as the desktop placement thereof, in accord with identifying these markers as the video is played to the end-user.

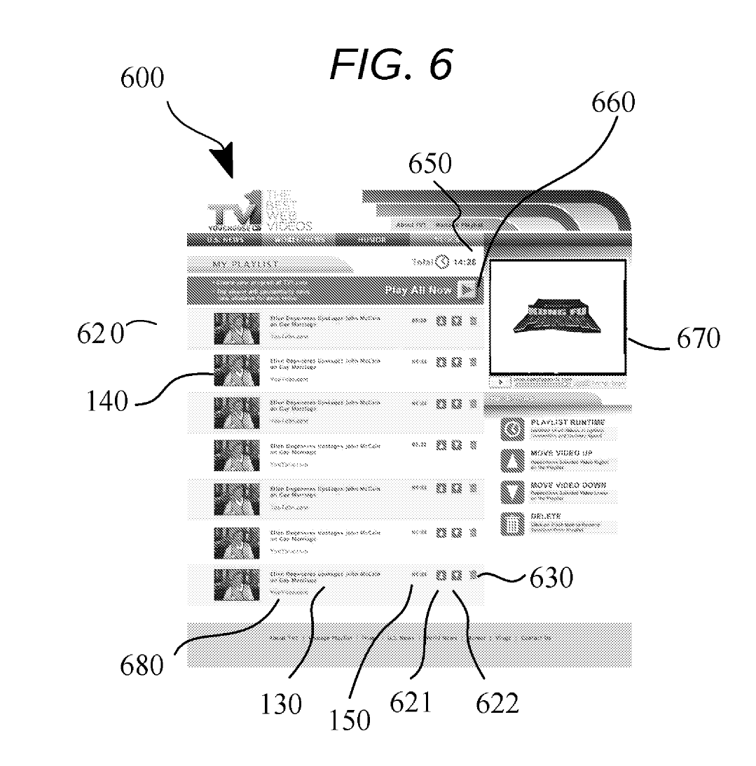

Absent, the video host sites providing such markers, an alternative embodiment of the invention is that the characterization step in FIG. 2A include the identification of unique attributes with the image and/or audio data of the video contained can be continuously tracked by the browser, script, native program or plug in. For example, the audio track of the video, which can be monitored as the video is played, can be characterized at the video portion of interest by a sound amplitude fingerprint described below with the aid of FIG. 5 Such fingerprints might simply be the time sequence between successive peaks and valley in amplitude at the play time the editor desires to “mark”. Thus in FIG. 5, in which the amplitude of sound is plotted on the ordinate and the time is plotted on the abscissa, such a sequence of time is represented by vertical bars labeled T1, T2, T3 and T4, the value of each being the time difference between the successive peaks in amplitude that the bar extends between. Thus, the script generated from the selections in the GUI 100 could also direct an application program interface to continuously monitor for the same fingerprint while the video is played. If the fingerprint is found then the browser can close the current window and go on to the next URL in the playlist.

Thus, such fingerprints and markers can be generated and associated with the beginning and end of the video of interest, with at least one or both characteristics being used to sequence the opening and closing of browser windows at the different URL to create a seamless viewing experience one the end user initiate the operation of play from the play list, even though multiple servers are accessed. For example, a fingerprint marker at the beginning of the video segment of interest could be used to move the window showing the video to the top of the window stack on the user's computer screen desktop. The fingerprint marker at the end of the video would be used to go to the next URL in the playlist associated script.

Other means of creating such fingerprint markers include characterizing specific pixel data in the video feed itself. That is, one combination of pixels of sufficient length is selected so that it has data unique to the first time tag and another combination of pixels of sufficient length is selected so that it has data unique to the next or last time tag. The pixel data preferably comes from a signal frame, but may include reference to more frame. As video compression techniques transmit the relative changes in portion of the pixel map, automated processing of the video image stream can be used to select the unique pixel data points. Thus, another sub-process in the characterization step of FIG. 2A is selecting the fingerprint, be it from audio or pixel image data, and more preferably verify its uniqueness within the video to correspond with the time segments the editor wishes to mark.

In another embodiment of the invention there is a method that deploys an automatic system in which once the end user sets a preference for the display of the GUI 100, which becomes a personalized page containing desirable videos for that end user that can be accessed through the system. Summaries of this personalized page could be delivered periodically to users through e-mail. Such preference might be in various embodiments the categories they wish to select from, as for example, and the end user might want their custom GUI to also offer a choice of news about a particle country, or reviews and/or news about a specific types of entertainment, for example movie review or short trailers of new movies released in the last month.

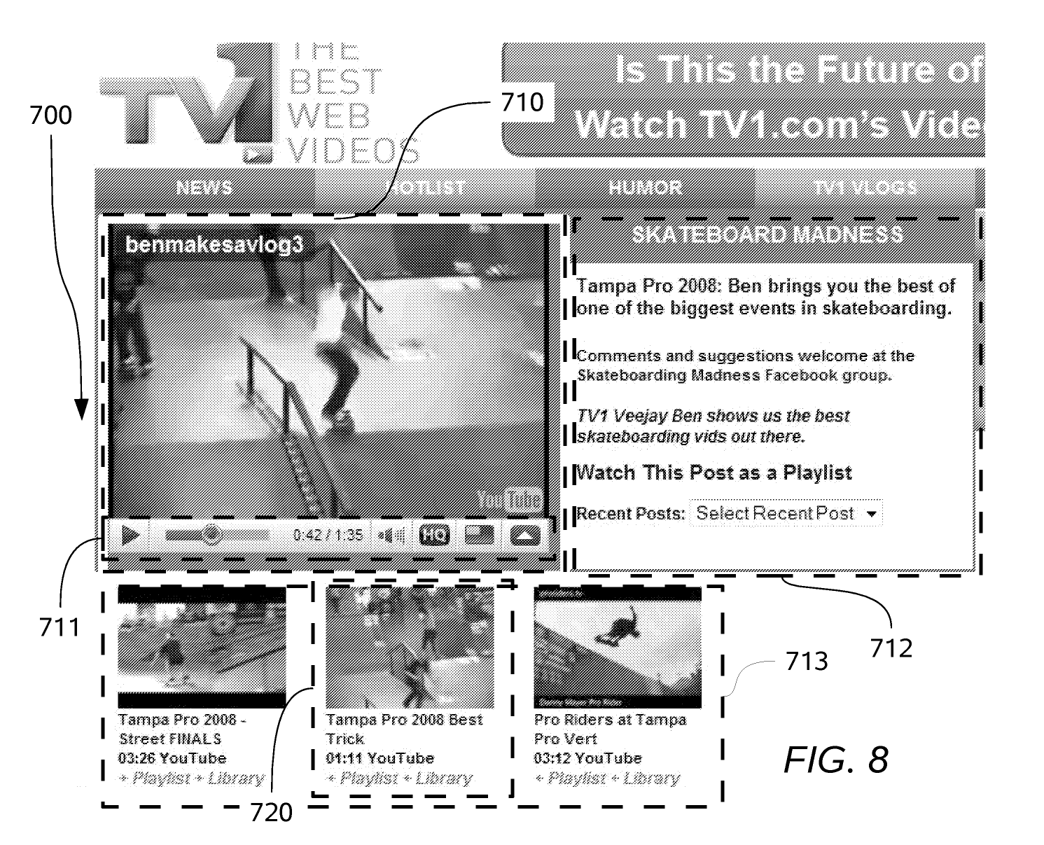

Another embodiment of the inventive system involves the end-user setting a preference of viewing selected collections of multiple videos selected by a known human agent that the agent finds of interest. This collection and the human agent's commentary thereon is referred to as a “Vlog”™, while the specific human agent is known as a “Vlogger”™. The “Vlogger” selection option would preferably be an additional column in GUI 100. The “Vloggers” might record periodic one minute long videos commenting on two to six web videos that are listed alongside their one minute videos. Thus, the “Vlogger” would be creating new video media that is accessible like other video's, being arranged in the last column 111 in the GUI 100 in FIG. 1. A “Vlogger” may be accessed by an end user through an automatic personalization script through which the end user sets a preference indicating which “Vloggers” to be included in the user's personalized page, which is GUI 100, after which the videos from those “Vloggers” are dynamically displayed on the user's personalized page. Once selecting a particular “Vlog” title in column 111, the user is next directed to the GUI 700 shown in FIG. 7.

The human agent or “Vlogger” creates subject specific “Vlog” which is a commentary on referenced videos that appear on the very same page; using select abstracting of portions of what they see. Such commentary can optionally be purely video or any combination of text or pure audio as well. Generally, the commentary would cover each of the video's the “Vlogger” has selected and made available for viewing on the system. The commentary would include selected portions of the actual video, but generally not such much as would violate the principles of fair use, along with commentary and additional textual information to allow viewers to focus on videos of interest or appreciate nuances between video of similar or the same subject. For example, commenting on or contrasting different sportsman athletic skill or teaching, or contrasting how different news organization report the same or similar events, such as to highlight media bias or spin by omitting materials or excluding other information.

FIG. 6 is an alternative and more preferred embodiment of the playlist 170 where it is displayed in a separate window after generation, without the matrix in the GUI 100 of FIG. 1. In the GUI 600 in FIG. 6, the playlist is displayed in sequential order in a single column; each entry 620 in the column representing a video the end-user has selected as described with respect to FIG. 1.

Entry 620 preferably includes a title 130, a still frame 140 from the video, and a play time 150. Further, information, such as the name of the home page 680 of the site hosting video is also included in entry 620. It may also optionally include any of the previously described information that was presented in the GUI 100 of FIG. 1, as well as additional information not listed in the GUI 100. Further there are control icons, in the form of up and down arrow buttons 621 and 622 respectively, that when activated cause an entry 620 to be moved up and down in the playlist order. In addition, the trash can icon 630 is operative when activated to delete the associated entry 620 from the playlist. The total playtime 650 for the entire play list is displayed adjacent the clock icon at the top right corner of the list. Activation of play icon or button 660 causes the list to be played in the final sequence shown in the GUI 600. GUI 600 also features an advertiser supplied video 670, which can be played in the browser window. Further, in any of the GUI's 100 and 600 just an individual video is optionally played by clicking on still frame 140 with the entry.

As various embodiments of the invention features video content selected by a human editorial process, it should be appreciated that the process would generally differ with the category of the content. As for example, news videos and humor videos would be selected through a comparable process, but each process follows specified editorial guidelines based on the category. News videos are preferably broken down by subject and are selected for their ability to integrate documentary footage with a minimum of “spin” or punditry. Comedy videos are selected from the top-viewed web video humor sites, based upon their popularity, “TV1.com”™ editorial selections, and “Out of the Blue” recommendations of lesser-known videos emailed to the editors.

Such an editorial process for humor videos might ultimately result for example a review of the four most popular humor videos from ten most popular humor sites all on one page, with the human editor then picking the four best of this group of 40. However, the other 36 videos might also be presented.

FIG. 7-12 illustrate additional preferred embodiments GUI's 700 for displaying, editing and creating playlists by the user or another human agents, such as the “Vlogger”. More specifically, FIG. 7-9 illustrates alternative views of a GUI 700 for viewing an interactive video editorial created by a human agent, i.e. the “Vlogger”.

Preferably there will be a “Vlogger” on every subject page that is accessible from the main menu shown in FIG. 1 or variants thereof, as for example with subjects will be everything from fashion to cooking to hockey and basketball and hip hop music, etc.

In FIG. 7, there is a frame 710 for viewing a video commentary, which preferably includes a sound track in which the human agent/“Vlogger” comments on a series of other videos that they believe will be of interests to visitors to the web site, all related to a specific subject under which they are indexed. Associated with the video for play in frame 710 is a playbar 711 having control icons for initiating play, controlling volume, and optionally stopping, pausing and rewinding the video, as well as switching to full screen mode, and other functions associated with the play of videos such as changing the screen size and play resolution.

As the video is played in frame 710 using the control button on in playbar 711 of the GUI 700, the viewer/user sees the commentator and then segments from the full videos that they are commenting on. Each of these video is available for viewing in its entirety using a different portion of the GUI 700. Preferably, these videos will be from a recent time period since the last posting or update by this human agent.

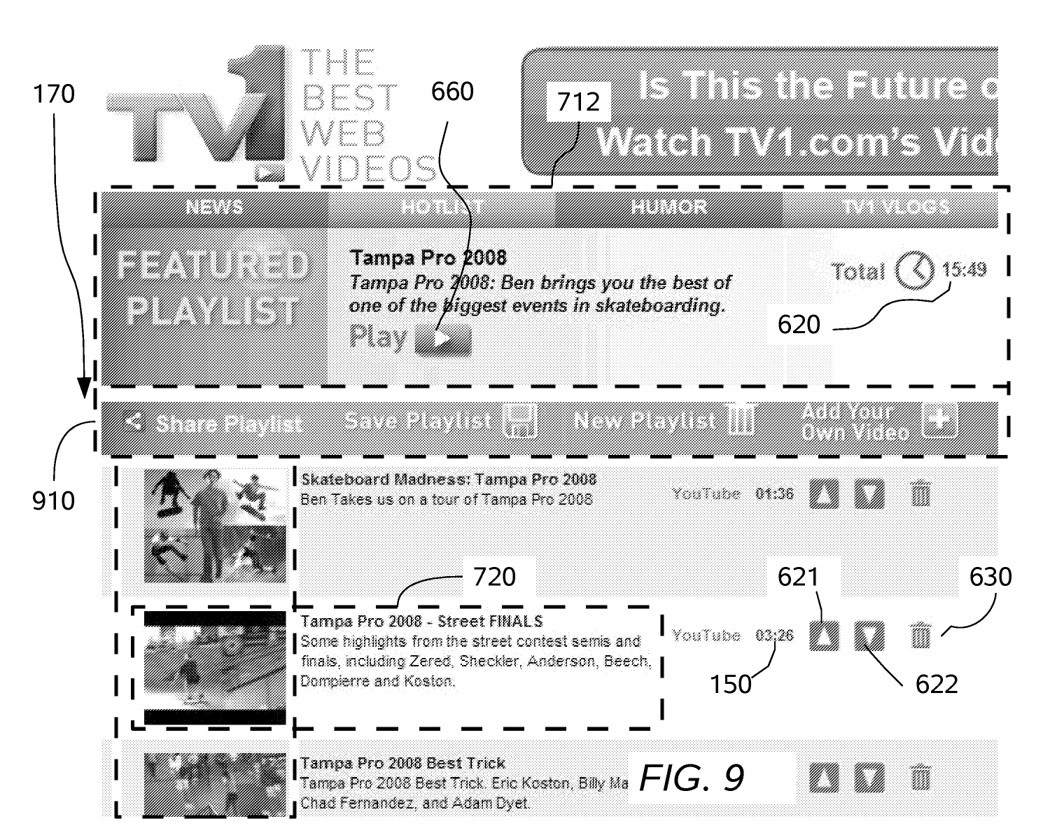

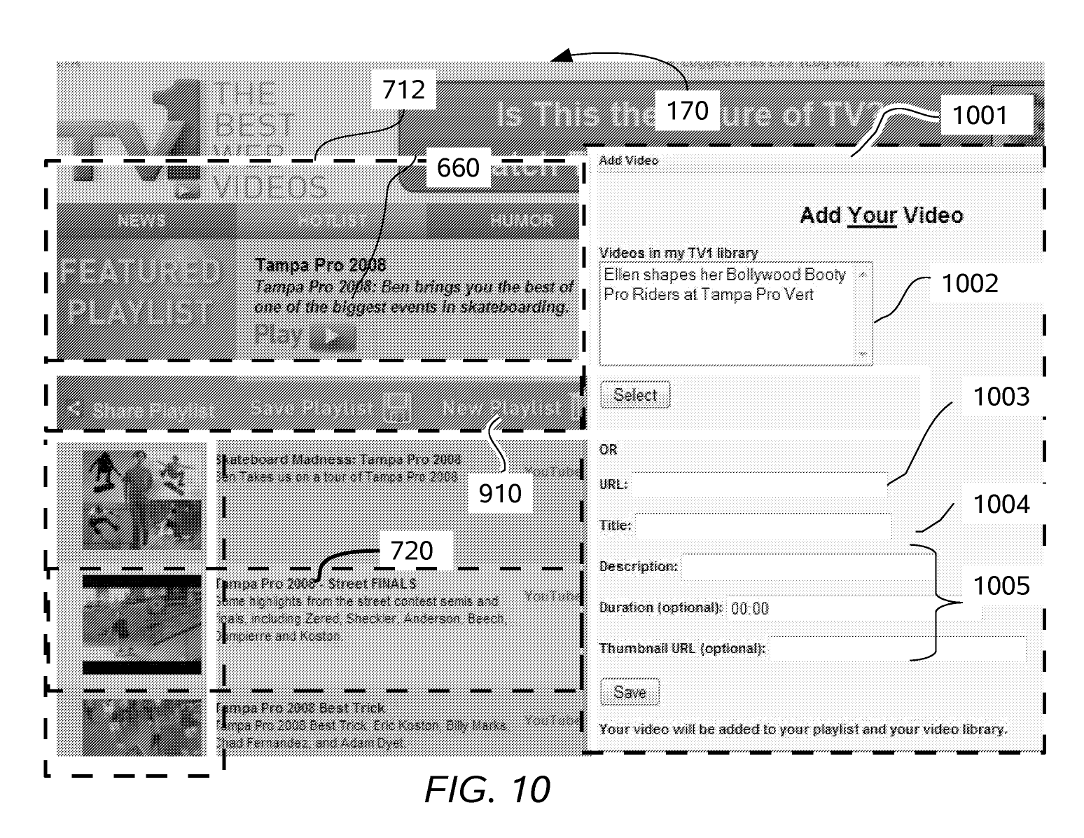

Also associated with the video for play in frame 710 is a bibliographic text box 712 that contains text to identify the name or pseudonym for the “Vlogger”, the title or subject of the “Vlog”, the date of the entry and the late, and may also include as shown a pull down menu to access older or different “Vlogs” by the same “Vlogger” or the same subject. There is also a the text control icon “Watch this Post as a Playlist” that is operative to modify how the sources videos 720 commented on by the “Vlogger” are displayed and accessible to the user, and in particular is for switching the view of GUI 700 to the playlist style GUI 170 shown in FIG. 9. In the views of GUI 700 in FIGS. 7 and 8, these source videos 720 are displayed in frame 713 as small “thumbnail” image of a representative frame of the video, along with the previously discussed bibliographic information on the video. Additional descriptive information may appear when a cursor is placed over this thumbnail view. Thus, this bibliographic information may optionally includes rating information, such as the quality rating assigned by a human reviewer, the number of times watched or played by others, a family suitability rating, the source of the video, the author or contributor, source hosting web site, playtime, title and the like. The thumbnail, text or an additional icon may be provided that is operative to cause the video selected from frame 713 to be played in its entirety in frame 710, using playbar 711. A still frame of the GUI in this mode of play is illustrated in FIG. 8, where the video title “Best Trick” is available to play through in its entirety with the “Vlogger's” commentary. It should be understood that the commentary may include portions of the original video with the sound track modified to provide a voice over by the “Vlogger”, while in the view in FIG. 8; the original sound track might be played. Alternatively, in other embodiments of the invention, the user would have other control icons to choose between commentary and the original sound track. In another optional embodiment, the “Vlogger's” written commentary for each video could appear or scroll as text in frame 712. Other icons could be available to turn on and off translations to different languages than the source video.

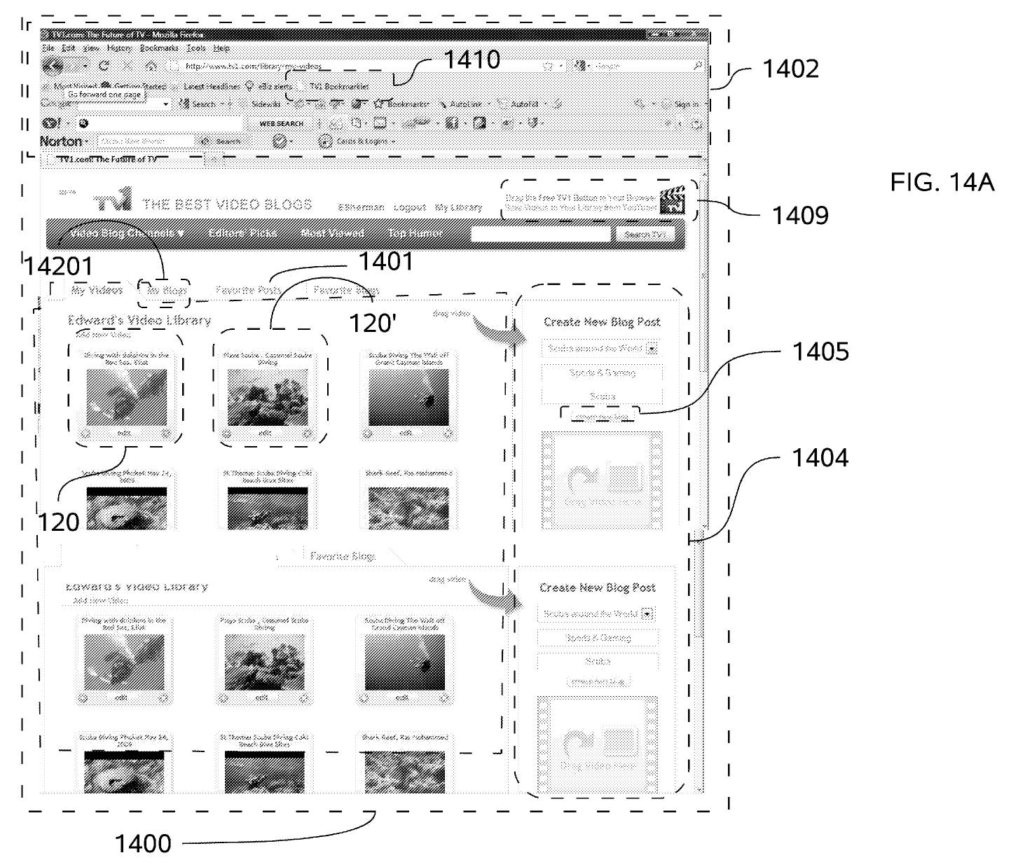

In addition to such textual comments there can be other links to source material as well as other videos, as well as commentary and links deposited by visitors who preferably register for such purpose essence what can be called a “social video network”, by using or interacting with the tool in the GUI described below with respect to FIG. 13.

The GUI 700 in FIG. 9 is comparable to that shown in FIG. 6, with frame 712 optionally supplying the same contextual information to the list as it did in FIG. 7-8, but now presents the available videos as a playlist 170. The video in frame entry 720 preferably includes a title, a still frame thumbnail from the video, and a play time 150. It may also optionally include any of the previously described information that was presented in the GUI 100 of FIG. 1, as well as additional information not listed in the GUI 100. Further there are control icons, in the form of up and down arrow buttons 621 and 622 respectively, that when activated cause an entry 720 to be moved up and down in the playlist order. In addition, the trash can icon 630 is operative when activated to delete the associated entry 720 from the playlist. The total playtime 650 for the entire play list is displayed adjacent the clock icon at the top right corner of the list. Activation of play icon or button 660 causes the list to be played in the final sequence shown in the GUI 700. GUI 700 may also optionally feature an advertiser supplied video, which can be played in the browser window of frame 710, which would also open when the user selects the video for play from the thumbnail icon or the entire playlist 660 icon.

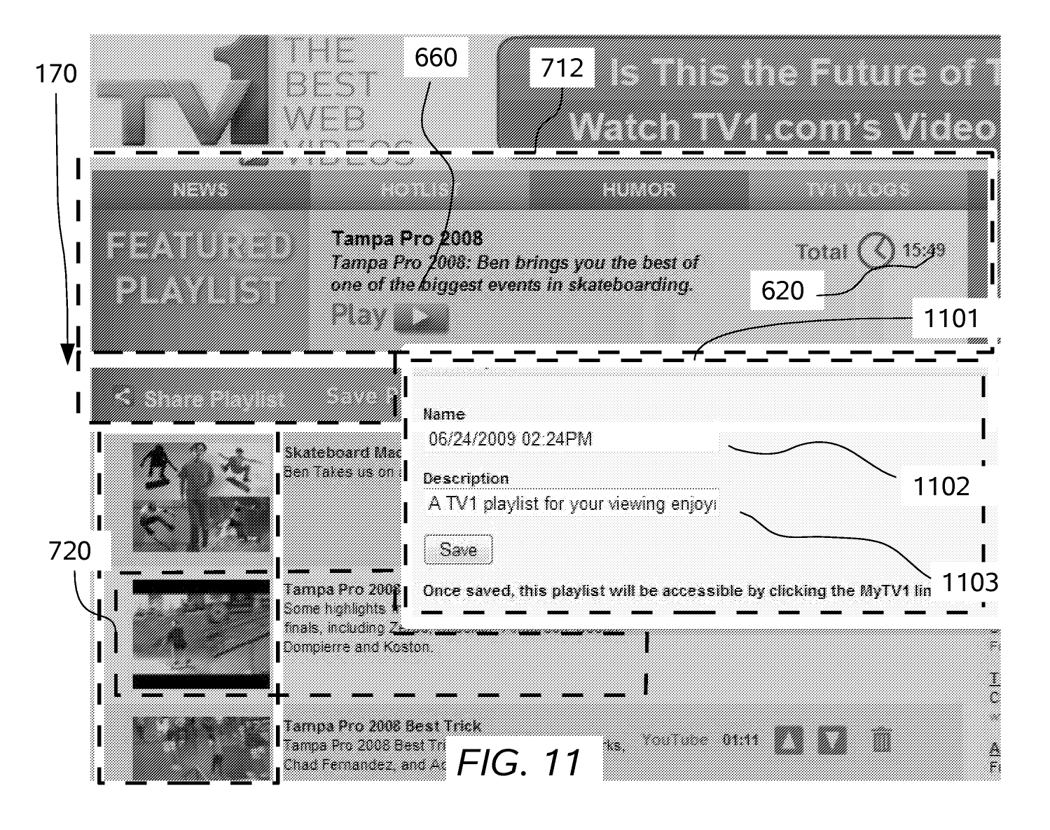

FIG. 10-12 show examples of how the playlist GUI of FIG. 9 can itself be edited, saved and shared by the user or the creator of a “Vlog”. For example, activating the icon labeled “Add Your Own Video” in frame 910 in FIG. 9 causes the display of a new GUI of playlist 170 in FIG. 10 in which a new dialog box 1001 opens. Dialog box 1001 now has user fillable fields 1002 for adding or selecting a video the user has previously stored in a reference database, either on their computer or a hosting server, which is then uploaded to the playlist when the “select” icon is activated. Alternatively, they can add a video found elsewhere on the World Wide Web or Internet by adding a URL in text field box 1003. The title of the video selected or uploaded from another URL is added in text field box 1004, and text field box 1005 accepts the addition of further video bibliographic information such as the description, duration and a thumbnail via a UR, that might ultimately be display with the icon or in the playlist. By then activating the “save” icon, the user causes the upload of the designated video to the playlist.

Hence, the “Vlogger” can use the GUI in FIG. 10 to create a new playlist which contains a video they created commenting on other videos, as well as adding the source video, those commented on, by entering their URL's in text field box 1003.

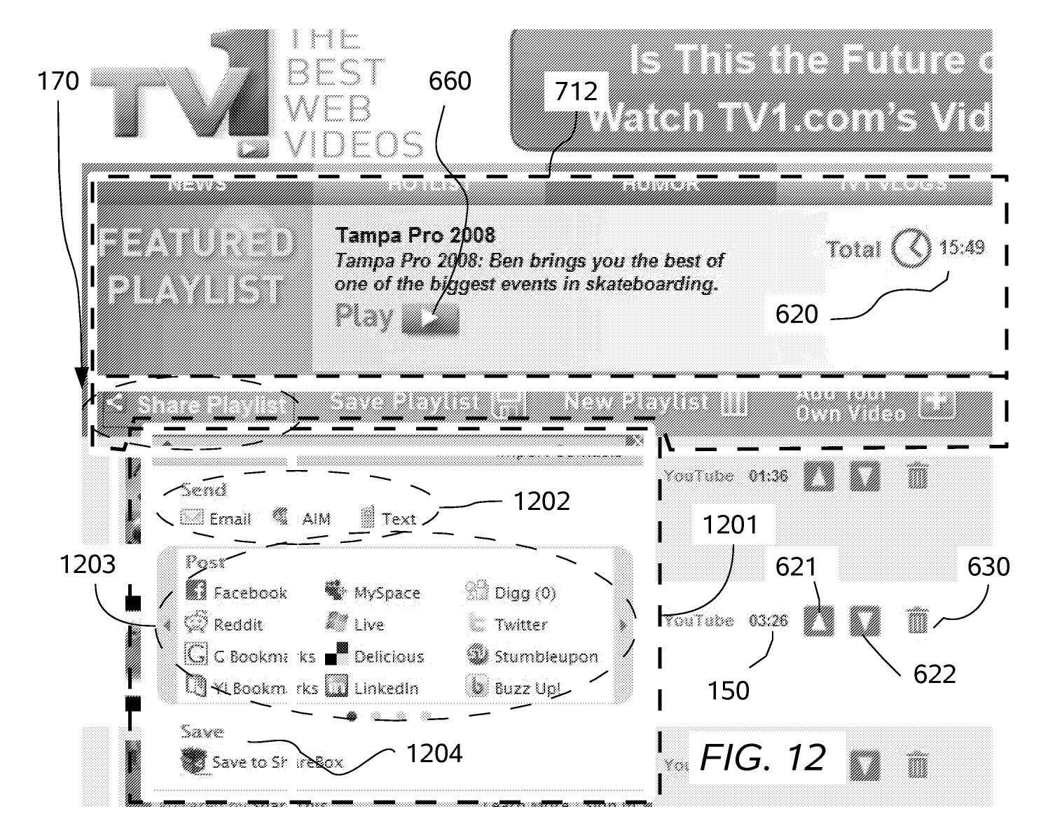

The “Vlogger” or another user can then by activating the icon labeled “Save Playlist” in frame 910 in FIG. 9 causes the display of a new GUI in FIG. 11 in which a new dialog box 1101 opens. Dialog box 1101 now has user fillable fields 1102 for adding a name for the playlist the user has created from the their own video or commentary on video, or another commentary and associated video with additional modifications, or any other playlist described elsewhere in this specification. The default name appears in this case as the date and time in filed 1102. Text field 1103 allows the user to enter a description for this play list, after which activating the “saved” icon causes the upload of the corresponding URL and play order to the host website which is later accessible to the user.

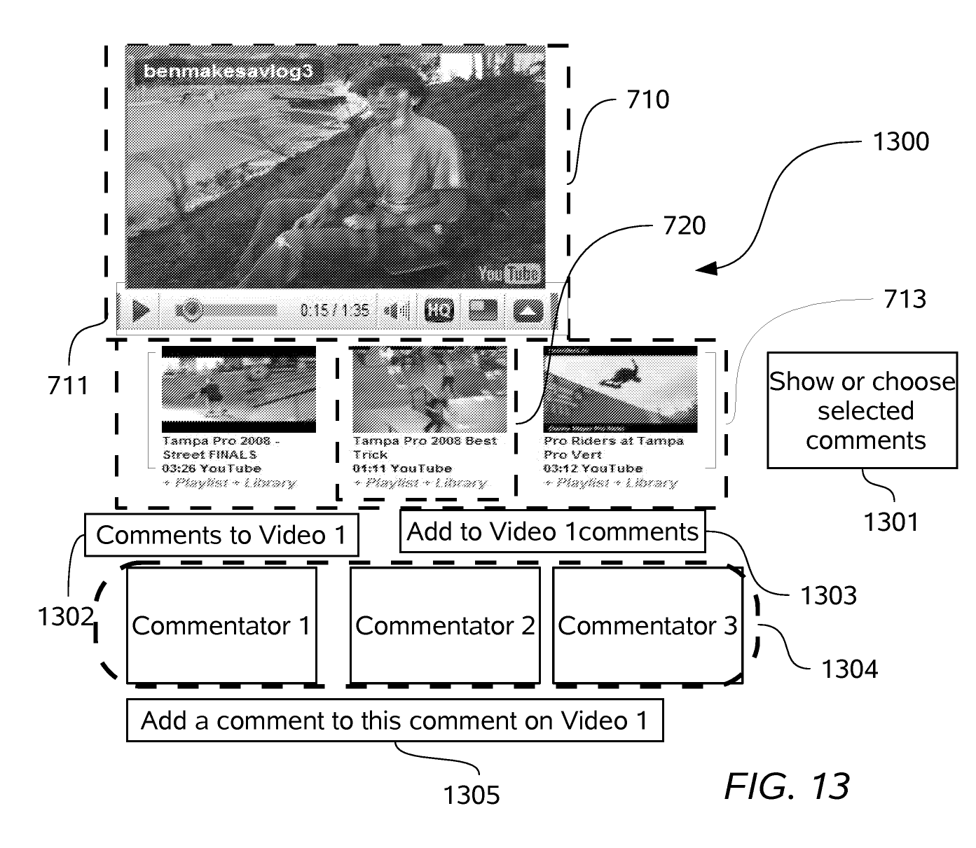

Alternatively, by activating the icon labeled “Share Playlist” in frame 910 in FIG. 9 causes the display of a new GUI in FIG. 12 in which a new dialog box 1201 opens. Dialog box 1201 now has a series of icons 1202 the activation of which initiates further dialogs for sending the playlist by e-mail, AIM or Text, such as a text message to a phone or any other form of electronic communication. Dialog box 1201 now has a series of icons 1203 the activation of which initiates access to the selected social or networking website. Alternatively by selecting the icon “SAVE” 1204 the user can upload the saved playlist to a shared web site accessible to a list of users that are preselected.

FIG. 13 is another GUI 1300 that is operative for viewing and adding commentary either to the initial “Vlog” of FIG. 7, or the source videos 720 commented on in frame 713. Thus, GUI 1300 in addition to providing the controls and functionality of GUI 700 in FIG. 7, is also operative to permit the user to view to comments previously made to a video, such as video 1 (720) in frame 1302 (shown in frames designed by 1304) by actuating the icon of frame 1302 designated “comments to Video1”. A user or the “Vlogger” can add further comments to the comments list for video 1 or any other video in frame 713 by actuating the icon of frame 1303 designated “Add to Video 1 comments”. These icons then open up dialog boxes with text fillable fields for adding comments, and may also open dialog boxes such as 1001 in FIG. 10 to add commentary in the form of additional video, or combinations of video and text. For example, a skateboarder might comment on execution of a stunt by contributing a video of how they or a third party execute the same stunt, along with at their option text commentary or a title summarizing the gist of the video they contribute.

In other embodiments of the invention, the “Vlogger” can review the comments and then organize or edits them so only the best and most appropriate supporting comments or alternative viewpoints are shown. As for example, the “Vlogger” may take out what is inappropriate, rude, offensive or duplicative, as well as any other matter violating pre-established rules of use. Thus, in addition, in implementing the inventive system it is preferable to require authors of the video editorial commentary to the system also agree to enforceable principles before their content editorial content is hosted. It is further expected that in addition to commentators, such as the “Vlogger”, there can addition or secondary “Vloggers that form a user community will police and rate itself for such secondary content.

It should be appreciated that as videos on all manner of subjects can be found in an ever increasing number of locations on the Internet, the inventive system need not actually host them or replications thereof but rather by novel methods described herein can provides ordered and intelligent access without the need for significant server capacity, even though many users are likely to designate a customizable GUI interface.

Another aspect of this invention is a means to collect various URL's that represent videos found on different servers that host different web sites. The collection is in essence a library from which the vlog creator selects, organizes, annotates and edits at least some of the videos in this library into a playlist. The playlist, with appropriate annotation to help another users identify if the contents are of interest is then available on a first server for play by other users that reaches this server through another general purpose computer using hyper text transfer protocol (http). The playlist is activated via an icon on a GUI that is displayed with similar icons on related subject matter.

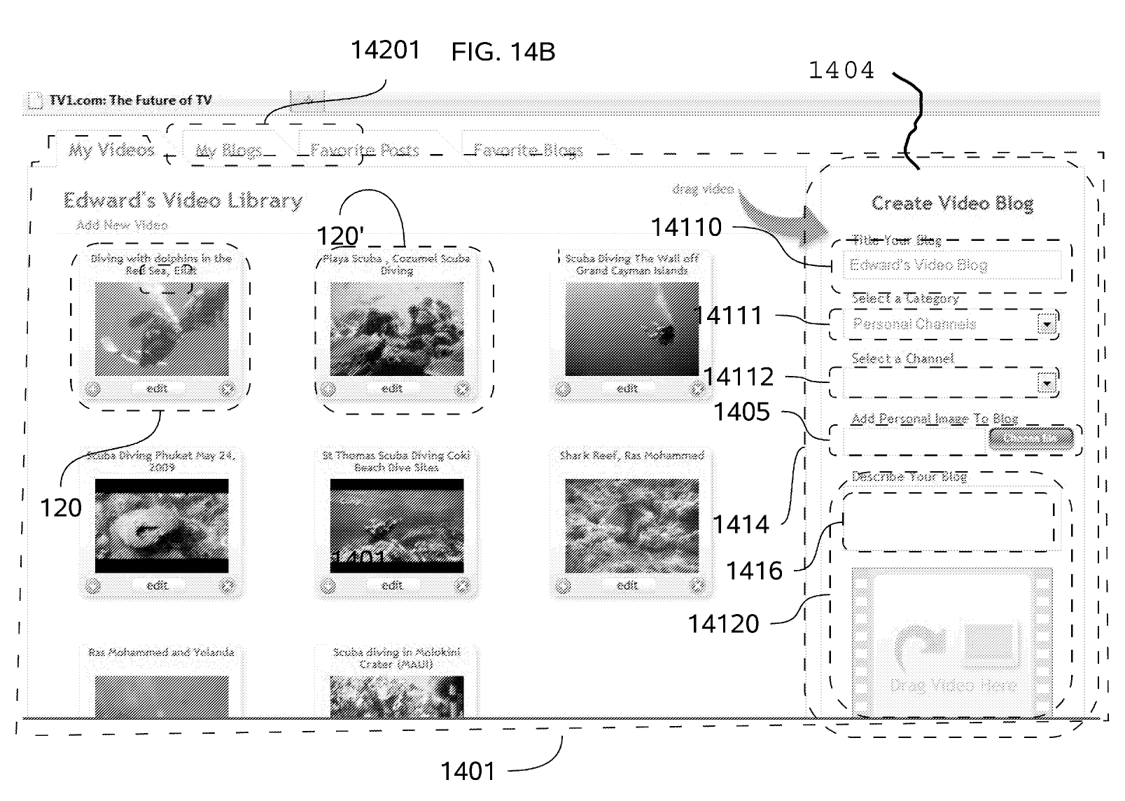

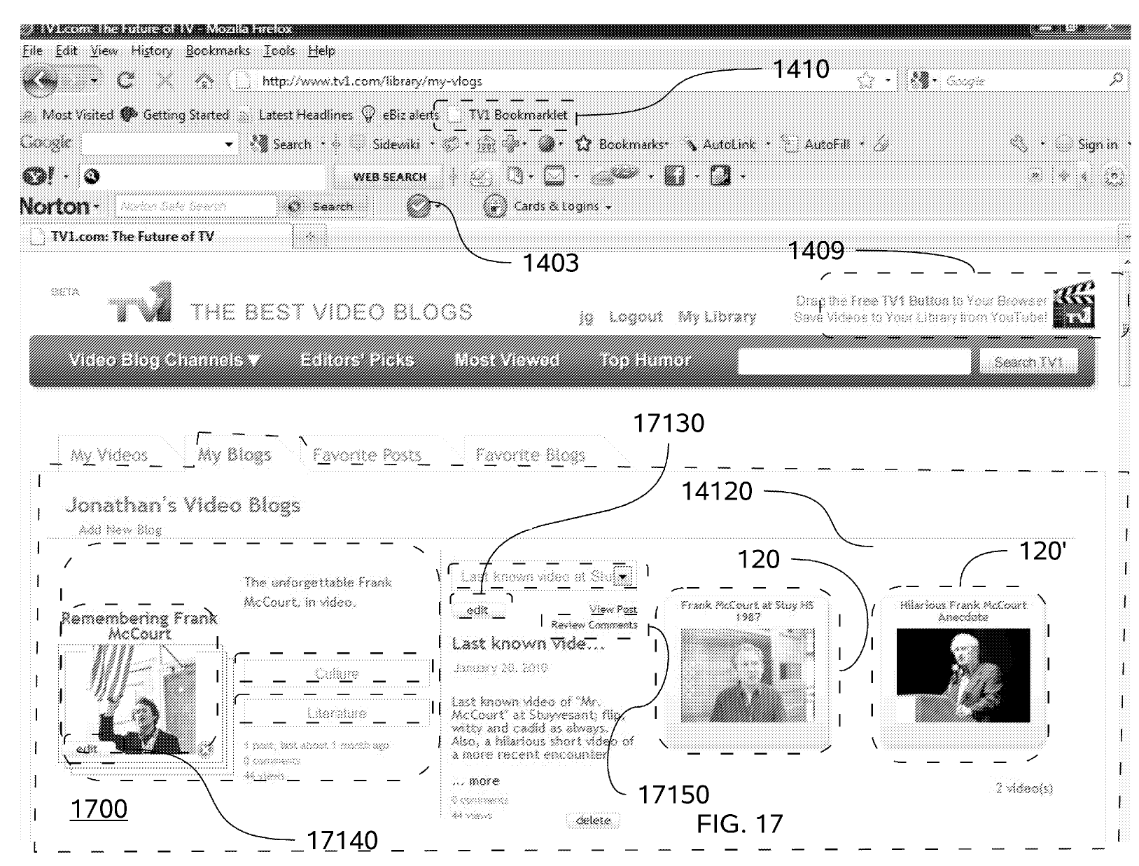

FIG. 14A illustrates a GUI 1400 for creating a vlog or blog after the user builds a library of video that are represented by URL's and thumbnail size images 120 in frame 1401. Frame 1401 can optionally display other content by selecting a tab icon such as 14201 to display the GUI 1700 in FIG. 17.

In GUI 1400 the Web browser itself has a largely conventional control frame 1402 but shows within it a principle frame 1401 for display of a video library using “thumbnails” images 120 and 120′ that are representative of videos that are available for possible addition to the vlog that is created via control icons in the frame 1404, titled “Create New Blog Post”. Thus by activating the icon in frame 1405, other fields in frame 1404 become accessible, as shown in FIG. 14B. Video thumbnails 120 represent URL's but preferably include a favored thumbnail image of the video as well as text that helps the user select which to add to the blog by manual moving or dragging the icon thereof across the GUI 1400 into frame 14120.

As shown in FIG. 14B, which shows just a portion of frame 1401 of GUI 1400, the adjacent frame 1404 has a sequence of sub-frames starting at title frame 4110 in the form of a user fillable fields for characterizing and describing the blog, as well as a frame 14120, represented like a film strip, for entering and arranging the display thumbnails from GUI frame 1401. The user operates the screen curser to drag video icons 120 from frame 1401 to frame 14120 where a copy is created to represent the play order of the video 120 in the newly created video blog. Video thumbnails 120 can be dragged and dropped in any sequence with respect to the thumbnails already populating frame 1420, to permit ordering of the video sequences in the blog.

The user fillable fields associated with videos and blogs are essentially an annotation involves two related aspects. The first is characterization of the content for indexing purposes. The second aspect is annotating the sub-content to aid the end user in appreciating the content and the vlogs editorial commentary thereof, as well as selecting the order or portion of the vlog they wish to view. The former annotation shall be referred to as the bibliographic abstract of the blog, which is optionally completed using the GUI of FIG. 14, and more specifically the entry field within frame 1404.

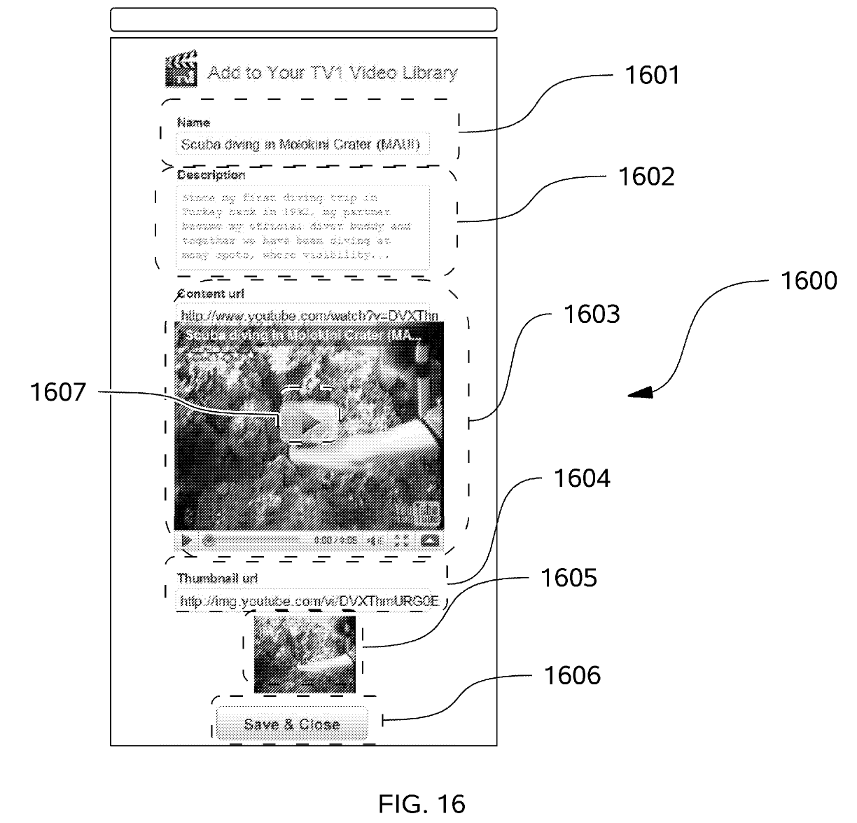

The second aspect of characterization is the video sub-content. The video sub-content can be created in the frame 1600 of the GUI in FIG. 16 at the time of capture of the video the user's library. Alternatively, a video frame 120 in the library frame 1401 can be opened for revision of the video summary from either video library GUI 1400, or the blog summary in the GUI 17000 in FIG. 17. The video segment specific sub-content is intended to be display or played simultaneously with the video content, as for example in the GUI 1800 in frame 1803 and 1804.

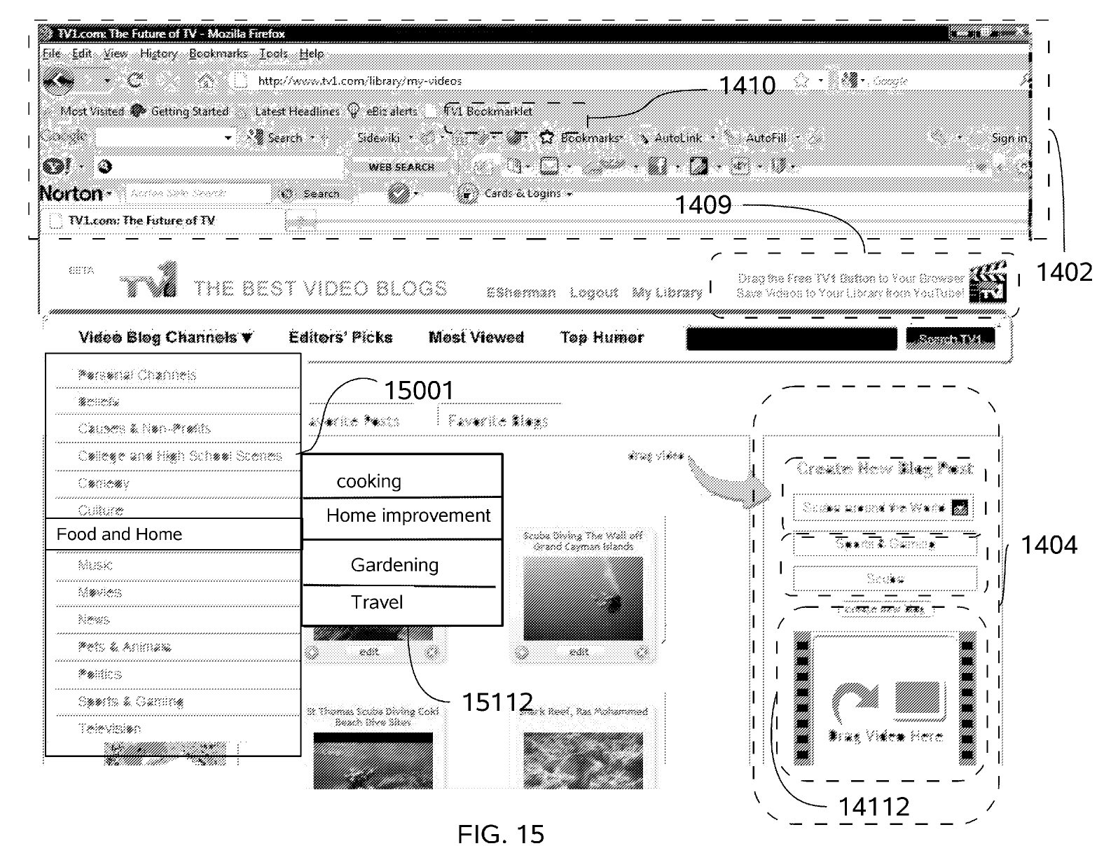

While the user is creating the bibliographic abstract of the blog they are free to enter any title in the text entry field within frame 14110 of the video blog. However, it should be appreciated the user fillable fields 14111 and 14112 have pull down menus that force the user to select categories from a master menu deployed for the benefit of all user of the system. This master menu can be considered a channel navigator of video blog channels, as shown in FIG. 15. The channel navigator 15001, is a pull-down menu that preferably appears on the top navigation of all pages, and is also preferably updated in real time as user's create new video blogs using the GUI 1400. Thus an important aspect of the GUI 1400 of the inventive system is coordination of blog creation with indexing to the channel navigator frame 15001. The process of creating the video blog by filling in the fields and adding video URLS to the frame 14014 (in FIG. 14B) updates the channel navigator for other users to access the video blog, such that new blogs must be entered in the pre-determined categories and channels of the channel navigator.

Further, the user can add a personal image to the blog using the control icon in frame 1414, and a description of the blog in user fillable text field in frame 1416. While the URL's of icons 120 can be added manually, it is preferred to capture them from another Web browser GUI that is playing the video using the bookmarklet icon 1410 in that appears in the Web browser toolbar frame 1402 gives users an easy way to add videos to their libraries. Thus, a user can view a video in any third party website in the normal browser window and activate bookmarklet icon 1410 with the curser to capture the URL and associated bibliographic information associated with it on the third party website. This action opens a new web page with GUI 1600 as part that has various icons and fields to edit the name, description, thumbnail URL of the selected video. Frame 1600 has user fillable fields in frame 1601 that allows the user to change the name associated with the video from that found with the URL on the hosting website or server. Field 1602 is similarly a more detailed description of the content. Frame 1603 display a thumbnail from the hosting website with a centrally placed control icon 1607 to play the video segment. Further, the URL to the video the playable content that was captured is displayed in frame 1604, with the video thumbnail from that URL shown in frame 1605. Accordingly, changes can be made in fields 1601 and 1602, to the title and description of the video segment which can be saved by activating the “save and close” icon in frame 1606. These controls allow users to upload their own video segments to multiple third party websites, but controlled how they are described and annotated in the context of being played in sequence as a blog.

The user input field in frame 1405 allows the user to upload a personal image to the blog by activating the “choose file” icon. This changes the thumbnail of the video as it appears in the blog when selected for play by a user.

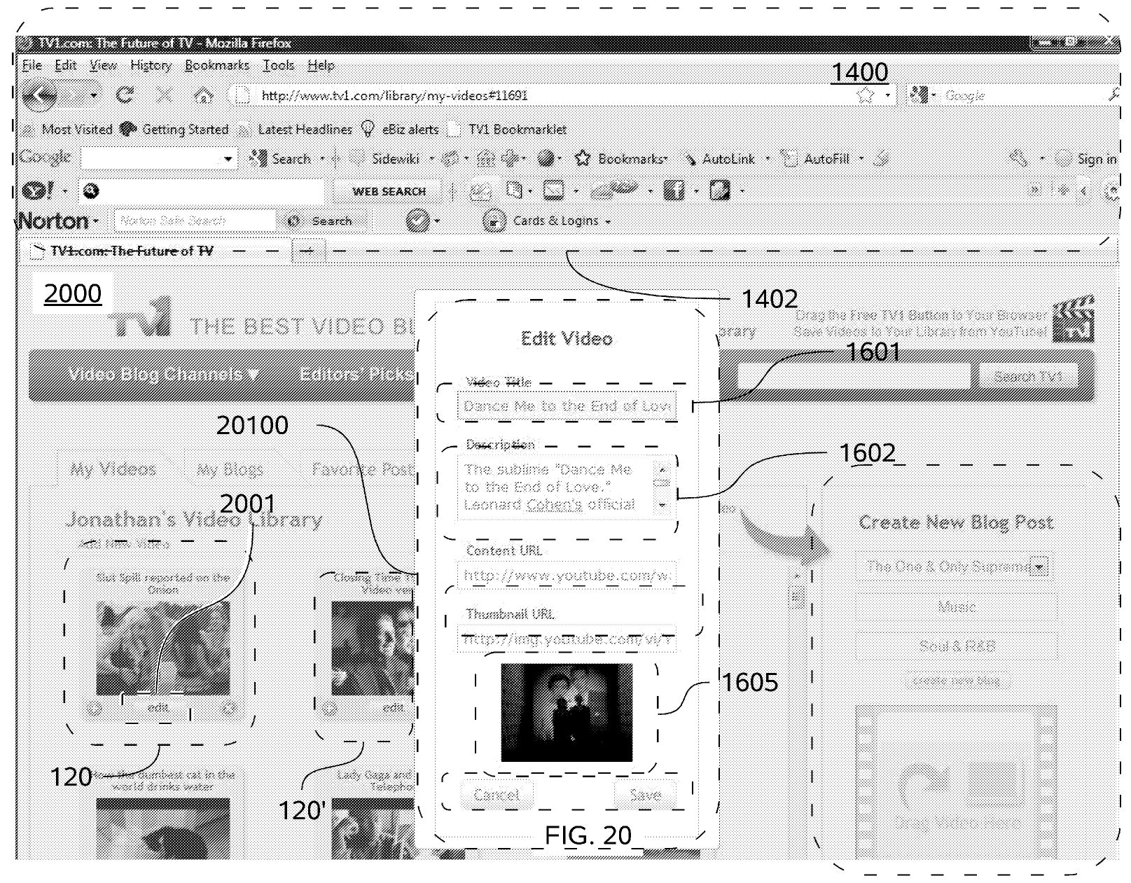

The sub-content of a video in the blog can be edited when video is captured using the GUI 1600 in FIG. 16 for editing a video segment after acquisition of its URL for addition to the user's video library. Alternatively, the sub-content of a video can be modified from the library GUI frame 1401 in FIG. 14A. As shown in FIG. 20, the selection of the edit “icon 2001 of video icon 120 generates another frame 20100 to alter the sub-content using multiple user fillable fields, that is title 1601m description 1602, the thumbnail URL 1605, as previously described with respect to FIG. 16.

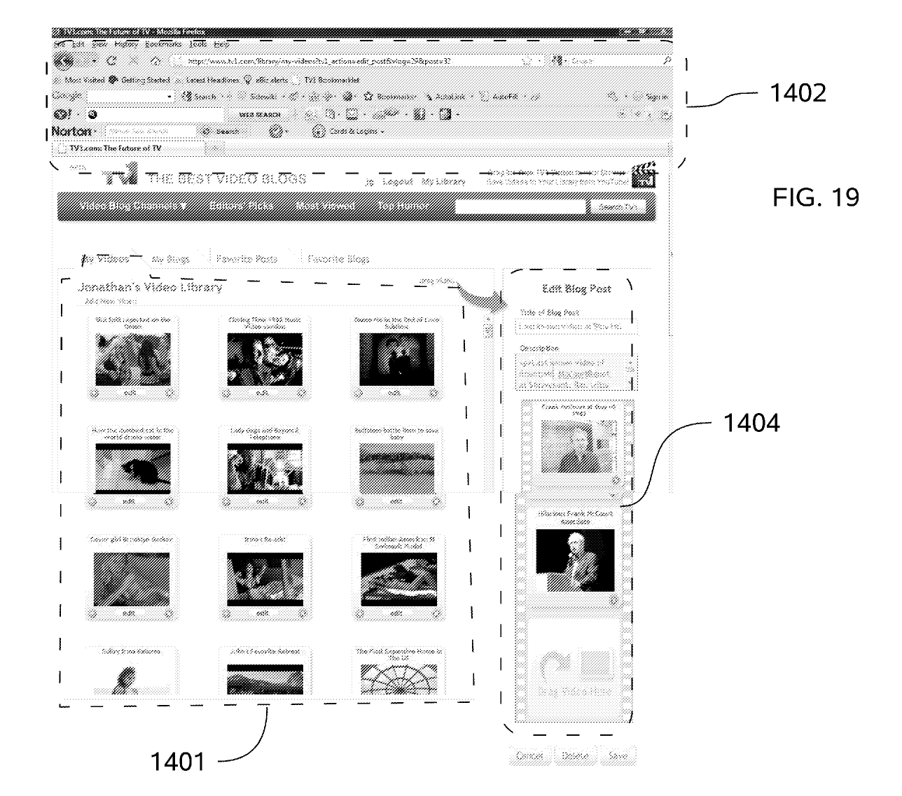

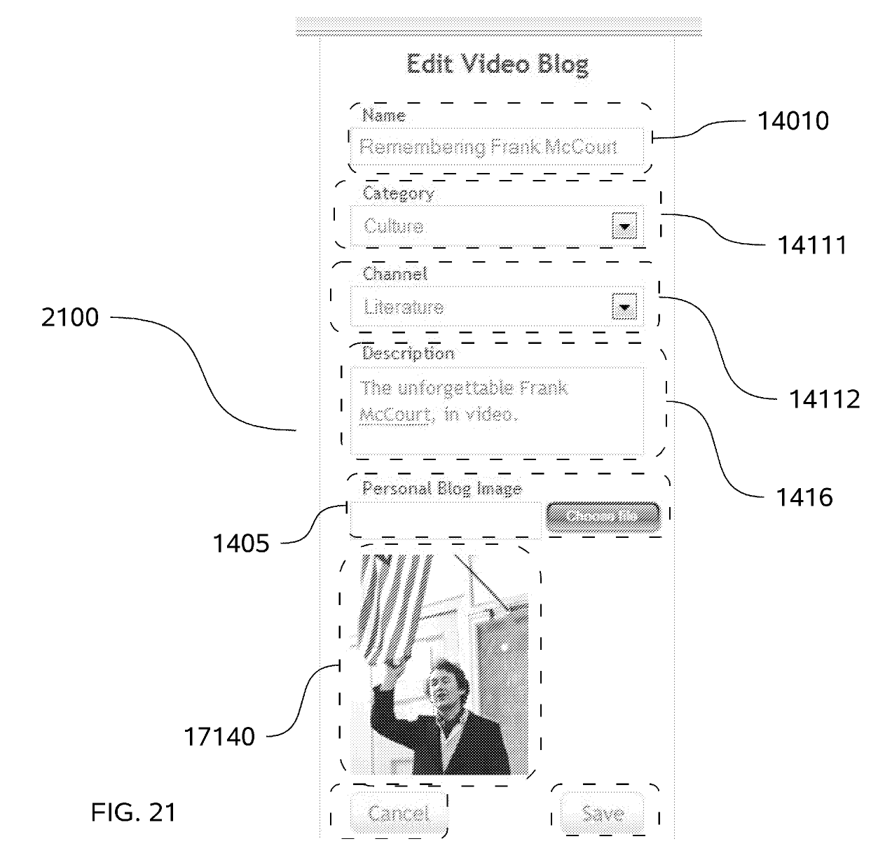

Alternatively, such editing of the blog bibliographic content is optionally initiated by selecting the tab titled “My blogs” in GUI 1400, which opens GUI 17000 as a folder, which is shown in FIG. 17. Thus, GUI 1700 is for viewing a library of video blogs created by the user and editing each blog therein. Activation of the edit” icon 17130 “generates the GUI 1900 in FIG. 19 allowing modification of the blog from the content in the user's library, that is by deleting video segment in frame 1404 or dragging them into frame 1404 form the library frame 101, or changing the order of the video in frame 1404. In contrast, the “edit” control 17140 opens the GUI 2100 in FIG. 21 for editing the bibliographic and summary information concerning the selected video blog as in the GUI 1400 of FIG. 14 when the vlog was created.

In GUI 1700 of FIG. 17, control icon 17150 allows the user to review comments to their blog, while control icon 17140 initiates play of the blog, for all video segments represented by icons 120 and 120′ in frame region 14120.

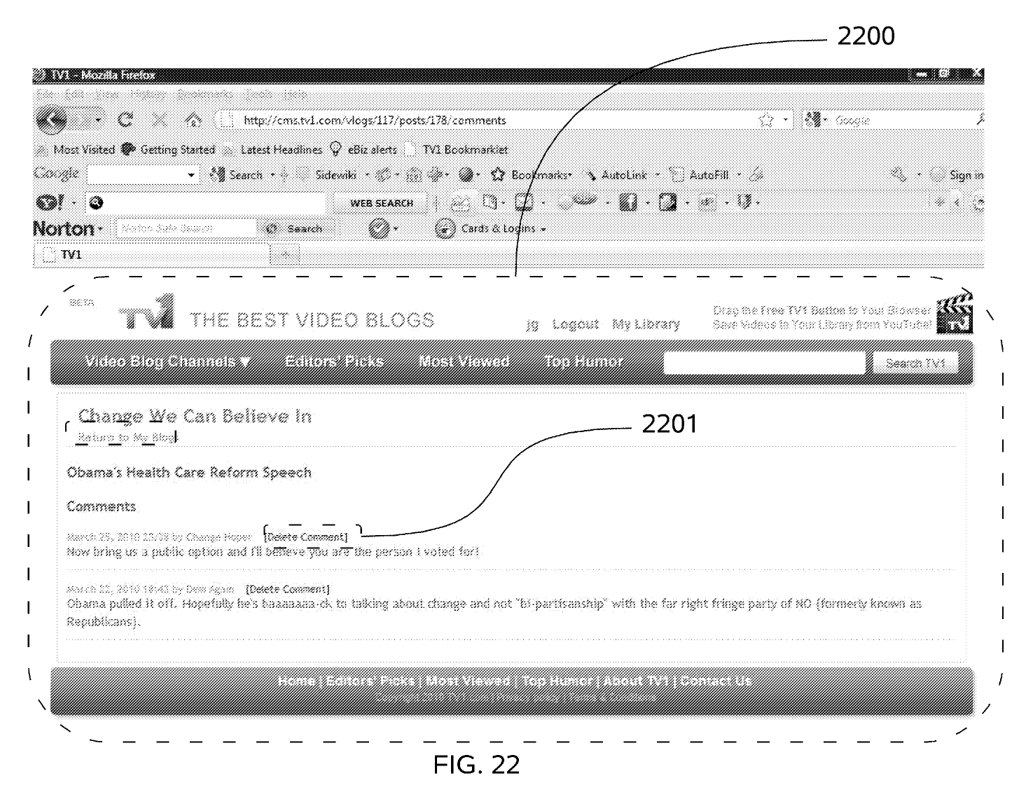

Thus activating the control icon 17150 opens GUI 2200 in FIG. 22, where the creator of the vlog can review and delete comments created by third party viewers of a video blog using control icon 2201.

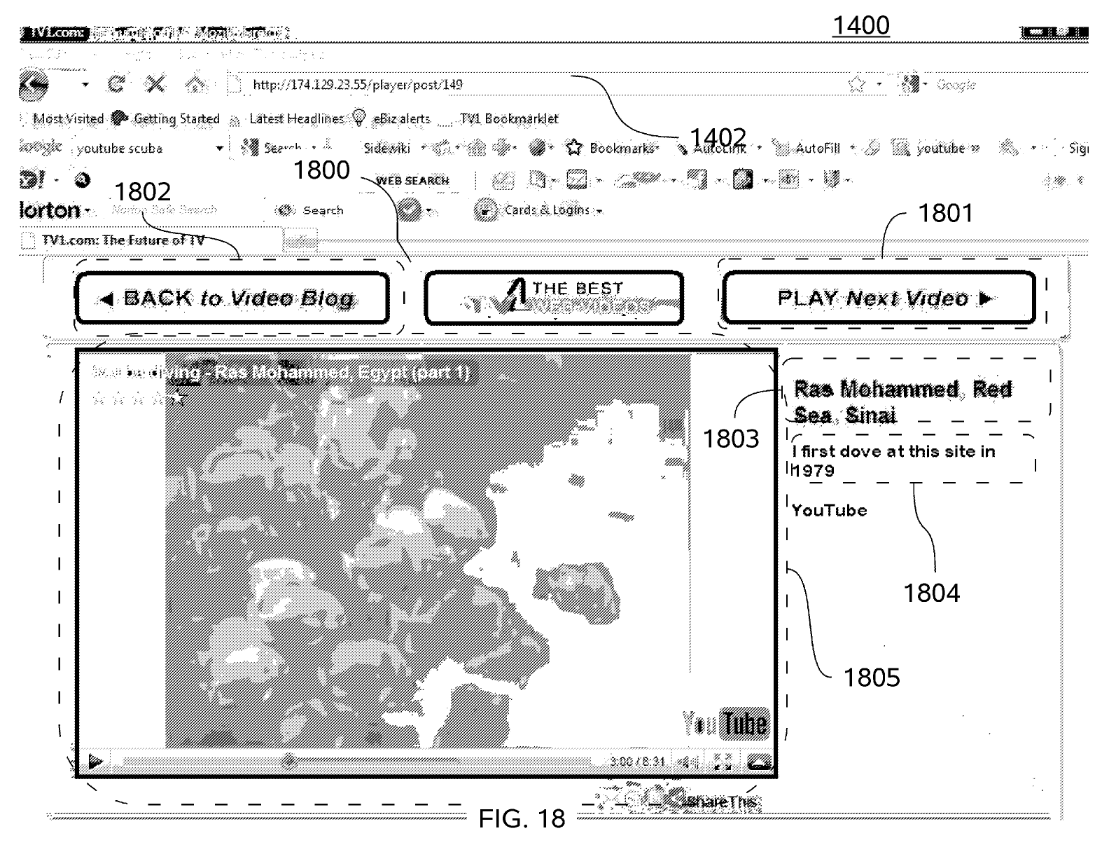

Thus, the vlog creation of the playlist described above generates a script that is run when the associated icon is activated. The script causes the playlist to be run, as displayed in the GUI in FIG. 18, in frame 1805, with the title of the blog now shown in frame 1803 and the sub-content of the video segment shown in frame 1804. Alternatively, portions of the blog can be played separately, should the user not wish to view the entire they can optionally use the sub-content to guide them to segments of the most interest, depending on their available time and interests.

Hence, the script described above has two functions, the first is to activate the streaming of video from a third party URL, which can be associated with any server, while at the same time as these video segment are streaming, as display or play the sub-content. The video is played in frame 1805 of GUI 1800, which has the conventional play controls such as start, pause stop and volume control along with a playbar and time indicator from the hosting URL of the video. Control icon 1801 advances play to the next video in the video blog sequence, whereas control icon 1802 return to the main page of the video blog.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1. A method of Internet video content management, comprising the steps of:
a) accessing one or more web sites hosting playable video content,
b) playing at least a portion of the video content in a GUI having a bookmarklet that is operative to activate a script for acquiring the URL of the playable content and the metadata associated therewith,
c) activating the bookmarklet to open a new GUI that displays the metadata associated with the video content that was played,
d) editing the metadata associated with the video content that was played,
e) storing the edited metadata and the URL of the playable content in a data structure that is computer readable.

2. A method of Internet video content management according to claim 1 further comprising the steps of;
a) accessing the data structure of the previous step to play the video URL's in sequence in a GUI having a first frame for playing each video segment and a second frame adjacent thereto for displaying the edited metadata of each video segment as it is played.
